(19) United States
(12) Patent Application Publication
(10) Pub. No.: US 2013/0257858 A1
(43) Pub. Date: Oct. 3, 2013

(54) REMOTE CONTROL APPARATUS AND METHOD USING VIRTUAL REALITY AND AUGMENTED REALITY

(71) Applicant: SAMSUNG ELECTRONICS CO., LTD., Gyeonggi-do (JP)

(72) Inventors: Jin-Hee Na, Seoul (KR); Pyo-jae Kim, Seoul (KR); Young-Kwon Yoon, Seoul (KR)

(73) Assignee: Samsung Electronics Co., Ltd., Gyeonggi-do (KR)

(21) Appl. No.: 13/782,647

(22) Filed: Mar. 1, 2013

(30) Foreign Application Priority Data
Mar. 30, 2012 (KR) 10-2012-0033238

(51) Int. Cl. G06T 15/00

(52) U.S. Cl. CPC G06T 15/005
USPC 345/419

(57) ABSTRACT

Methods and apparatus are provided for using a virtual space map. The virtual space map is generated and displayed. Communication between a character of an actual space and a character on the virtual space map is controlled.

### PRIORITY

This application claims priority under 35 U.S.C. §119(a) to Korean Application Serial No. 10-2012-0033238, which was filed in the Korean Intellectual Property Office on Mar. 30, 2012, the contents of which are incorporated herein by reference.

### BACKGROUND OF THE INVENTION

1. Field of the Invention

The present invention relates generally to a remote control apparatus and a method using virtual reality and augmented reality, and more particularly, to a remote control apparatus and method using virtual reality and augmented reality, which remotely controls a digital information device and the like, by using the virtual reality and the augmented reality.

2. Description of the Related Art

Virtual reality refers to an environment or a situation generated through computer graphics having an environment that is similar to that of reality. An interface allows a user to perceive the virtual reality through his/her bodily senses and feel as though he/she is really interacting with the virtual reality. The user can interact with the virtual reality through the control of a device in real time and can have a sensory experience similar to that of reality.

An augmented reality is one field of virtual reality, and refers to a computer graphic technology that combines an actual environment and a virtual object or virtual information, making the virtual object or the virtual information appear as if it exists in an original environment. The augmented reality is a technology that shows a virtual object and real-world viewed by user's eyes in an overlapping manner. The augmented reality is also referred to as a Mixed Reality (MR) since it combines the real-world with additional information and a virtual-world, and shows the combined world as one image.

A remote control technology using a mobile terminal corresponds to a method of remotely controlling various Information Technology (IT) devices or facilities, and grasping a situation in real time. Since information devices connected to the device of the user through a wireless network may be managed and controlled by the user, remote control technology has been frequently used in a home network, a security system and the like. A representative example of remote control technology is remotely operating a TV, a washing machine, or the like, within the home, by a person who is outside the home. Further, a remote interaction between users is performed in various types, such as, for example, a voice service, a video phone communication service, a messaging service, and the like.

However, since virtual reality technology focuses on making the user perceive that a virtual space is an actual space through the user's five senses, virtual reality technology is limited in that the actual space cannot be changed by reflecting an action performed in the virtual space to the actual space.

Further, remote control technology using a conventional mobile terminal is problematic in that it cannot provide a sensory experience, which makes the user feel as if he/she is really controlling the virtual reality, to the user. Virtual reality technology or augmented reality technology independently exists and a method of combining the virtual reality and the augmented reality has not been proposed.

### SUMMARY OF THE INVENTION

The present invention has been made to address at least the above problems and/or disadvantages and to provide at least the advantages described below. Accordingly, an aspect of the present invention provides a method of generating a virtual space in a mobile terminal and interacting with an object in the real-world by using a virtual character, and provides a remote control apparatus and method using virtual reality and augmented reality, which interact with a person who is remotely located through the virtual reality and the augmented reality.

In accordance with an aspect of the present invention, a remote control apparatus of a mobile terminal using a virtual space map is provided. The remote control apparatus includes a virtual space map generator for generating the virtual space map. The remote control apparatus also includes a display unit for displaying the virtual space map. The remote control apparatus further includes a controller for controlling communication between a character of an actual space and a character on the virtual space map.

In accordance with another aspect of the present invention, a remote control method of a mobile terminal using a virtual space map is provided. The virtual space map is generated. The virtual space map is displayed. Communication between a character of an actual space and a character on the virtual space map is controlled.

In accordance with an additional aspect of the present invention, a machine readable storage medium is provided for recording a program for executing a remote control method using a virtual space map. When executed the program implements the steps of: generating a virtual space map; displaying the virtual space map; and controlling communication between a character of an actual space and a character on the virtual space map.

In accordance with a further aspect of the present invention, an article of manufacture is provided for performing remote control using a virtual space map, including a machine readable medium containing one or more programs, which when executed implement the steps of: generating a virtual space map; displaying the virtual space map; and controlling communication between a character of an actual space and a character on the virtual space map.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other aspects, features and advantages of the present invention will be more apparent from the following detailed description when taken in conjunction with the accompanying drawings, in which:

FIG. 1 is a block diagram illustrating a remote control apparatus using a virtual reality and an augmented reality, according to an embodiment of the present invention;

FIG. 2 is a block diagram illustrating a character control apparatus using a virtual space map, according to an embodiment of the present invention;

FIG. 3 is a flowchart illustrating virtual space map generation and a remote control method of a mobile terminal through the virtual space map generation, according to an embodiment of the present invention;

FIG. 4 illustrates an example of generating a virtual space, according to an embodiment of the present invention; and

FIG. 5 illustrates an example of interacting between mobile terminals through a virtual space map and controlling a character within the virtual space map, according to an embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention. Further, terms which will be described below are terms defined in consideration of functions in embodiments of the present invention and may vary depending on a user, an intention of the user, a practice, or the like. Therefore, definitions will be made based on contents throughout the specification.

Embodiments of the present invention provide a remote control apparatus and a method using virtual reality and augmented reality, which remotely control a digital information device by using the virtual reality and the augmented reality, so that it is possible to manage and control an actual character on a virtual space in a manner similar to performance in the real-world through an intuitive method, and to generate and store a virtual space map in a mobile terminal after photographing spaces where a user frequently stays. Further, when there are multiple registered spaces, the spaces may be grouped according to various methods, such as, for example, a division for each position or type of the space, and the grouped spaces may be managed. Moreover, it is possible to manage another object existing in the space by informing another user, in real time, that the user enters the space. Furthermore, it is possible to know, in real time, information on a mobile terminal accessing the same space and to interact with another mobile terminal existing in the same space.

The virtual space map may be configured in a three-dimensional space by signal-processing information of a camera or a sensor mounted to the mobile terminal. In addition, position information of the character in an actual space corresponding to the generated virtual space map may be input from the user or input by using an recognition technology. The position information may be located on the virtual space map. When the user executes the virtual space map in the mobile terminal, the character is generated within the virtual space map. Further, the user can control a character in the actual space by moving and controlling the character in the virtual space. In addition, virtual space maps generated by the user may be grouped within the mobile terminal according to position information of the space and user's convenience. The grouped virtual space maps may be managed, and may be expressed in an icon type and easily accessed by the user through a Graphic User Interface (GUI).

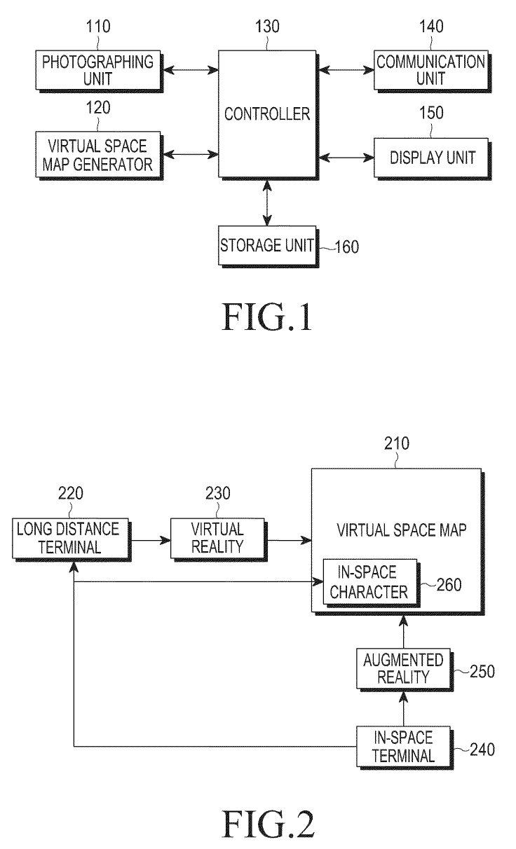

FIG. 1 is a block diagram illustrating a remote control apparatus using a virtual reality and an augmented reality, according to an embodiment of the present invention.

As illustrated in FIG. 1, the remote control apparatus using the virtual reality and the augmented reality, according to the embodiment of the present invention, includes a photographing unit 110, which includes one or more camera modules to generate a three-dimensional virtual space map showing the virtual reality. The remote control apparatus also includes a virtual space map generator 120 for generating the virtual space map through an image photographed through a camera, and a controller 130 for controlling communication between a character in an actual space and a virtual character on the virtual space map corresponding to the character in the actual space. The remote control apparatus also includes a display unit 150 for displaying the generated virtual space map, and a communication unit 140, which includes one or more communication modules for providing communication with an actual character corresponding to the virtual character on the virtual space map. The remote control apparatus further includes a storage unit 160 for storing the generated three-dimensional space map and one or more virtual space maps. The controller 130 is included within each mobile terminal, and controls communication with a remote terminal, which may be geographically remotely located, or controls communication between in-space terminals located within the actual space corresponding to the virtual space map.

The photographing unit 110 photographs the actual space through the one or more cameras. The photographing unit 110 photographs the actual space in a panorama mode, or while rotating 360 degrees. Further, the photographing unit 110 acquires information required for generating the three-dimensional virtual space map through a sensor, such as, for example, a gyro sensor, a depth sensor, or the like, in the photographed image. In addition, the accuracy of the three-dimensional virtual space map can be improved through a data fusion process. As described above, the photographing unit or a camera unit includes one or more camera modules for photographing the actual space to generate the virtual space map.

The virtual space map generator 120 extracts and traces a feature (or a texture) from the photographed image. Further, the virtual space map generator 120 estimates a pose of the camera while photographing the actual space based on the feature, and then can generate the three-dimensional virtual space map by using map generation and compensation technology. The compensation technology includes Simultaneous Localization And Mapping (SLAM). In an environment where other sensors such as the gyro sensor, the depth sensor and the like can be used, the accuracy of the three-dimensional virtual space map can be improved by fusing image information and sensor information. When the virtual space map is generated, a map provider or each mobile terminal registers characters existing in the actual space in the virtual space map. Further, at a later time, the mobile terminal, having the virtual space map and located in the actual space, photographs the actual space by a camera installed therein, and then calculates an orientation of the camera and a position within the space. In addition, the user executes the virtual space by using the mobile terminal of the user having the virtual space map. Thereafter, the user can search for the character of the actual space by using the virtual character existing on the virtual space map, and view annotation information on the characters registered in the virtual space map through a preview image. The registered character include, for example, a TV, a washing machine, a refrigerator, a copy machine, a digital photo frame, an electric curtain, and the like, which have communication functions therein, and a wardrobe, a bookshelf, and the like, which do not have communication functions therein.

The controller 130 calculates a position of the camera by using SLAM technology in the image photographed through the camera. Specifically, the controller 130 extracts features (or textures) through the photographed image and calculates in real time the current position and of the camera and its position on the map through a process of matching the extracted features with features on the virtual map. When other sensors, such as the gyro sensor, the depth sensor, and the like, can be used, the accuracy of the current position and the orientation of the camera can be improved by fusing image information and sensor information. Further, the controller 130 controls communication between a remote terminal, which may be geographically remotely located and an in-space terminal located within the virtual space map, and also controls communication between the character of the actual space and the virtual character on the virtual space map. The remote terminal may pre-store the virtual space map or receive the virtual space map from an actual mobile terminal and a server providing the virtual space map. Further, the in-space terminal may pre-store the virtual space map or receive the virtual space map from the remote terminal and the server providing the virtual space map. As described above, the remote terminal and the in-space terminal may be newly named according to the current position.

The controller 130 controls communication between the character of the actual space and an augmented character shown in the preview image photographed through the camera. The augmented character is a character corresponding to the actual character in the preview image photographed through the in-space terminal within the virtual space map. The preview image is an image shown in real time before the image is photographed, and the user photographs the image after composing the image through the preview image. Further, the controller 130 can control a motion of the character on the displayed virtual space map through a keypad, a touch input, a motion sensor, or the like. As described above, in order to control communication between the actual character and the character on the virtual space map, and the communication between the remote terminal and the in-space terminal located in the actual space, the controller 130 allocates an inherent identifier allocated to the actual character to the virtual character on the virtual space map. As described above, an address allocated to an information processing device existing in the actual space is input to the corresponding character of the virtual space in order to control the communication between the character of the actual space and the virtual character. Further, the controller 130 can register or delete the character in or from the generated virtual space map. The information processing device includes a TV, a washing machine, a refrigerator, a copy machine, a computer, and the like, existing within a home, an office, and the like. Specifically, the controller 130 registers the corresponding character, which the user desires to manage and control, in the virtual space having the same position as that of the actual space. The registered character may be a communicable information processing device or a character having no communication function, such as a desk. When the virtual space is executed, the virtual character is placed within the space and the virtual character can be moved in real time within the space by using a touch device, a keypad, a motion sensor, and the like, of the mobile terminal. The virtual character may move in the virtual space in the third or first person perspective. When the character of the actual space is photographed after the mobile terminal is placed in a position close to the character of the actual space, the virtual character corresponding to the character of the actual space, that is, the augmented character, appears in the preview image photographed through the photographing unit of the mobile terminal. Further, the mobile terminal can provide mutual communication between the character of the actual space and the augmented character, or control an operation of the character of the actual space corresponding to the augmented character. When the character of the actual space subject to the interaction is a general character, which does not have a communication function, such as a bookshelf, information on the general character may be upgraded or managed within the virtual space map.

The user can register a plurality of virtual spaces through the above method, and group the registered virtual spaces according to a type or a position of the actual space. The grouped virtual spaces are managed. Further, the user can select a virtual space to be activated, by using position information of the mobile terminal or through an input of the user. When the three-dimensional virtual space map is executed, the mobile terminal can inform another user existing within the space that the mobile terminal enters the virtual space.

The communication unit 140 includes one or more communication modules for providing communication between the character of the actual space and the virtual character on the virtual space map, corresponding to the character of the actual space, or for providing communication between the in-space terminal existing in the actual space and the remote terminal, which does not exist in the actual space. Further, the communication unit 140 includes a communication module for performing communication between the character of the actual space and the augmented character, through the generated virtual space map. In addition, the communication unit 140 includes one or more communication modules for transmitting a command input to control the character of the actual space through the character on the virtual space map displayed in the display unit to the character of the actual space. The display unit displays the virtual space map and also displays the preview image photographed by the camera. Further, the display unit inserts information on the actual character in the preview image and displays the preview image. In addition, the display unit can receive a command as a touch function as well as a function of displaying the virtual space map and the preview image.

FIG. 2 is a block diagram illustrating a character control apparatus using the virtual space map, according to an embodiment of the present invention.

The virtual space map, according to an embodiment of the present invention, is generated through a camera mounted to the mobile terminal. The virtual space map includes a character corresponding to one or more devices existing in the actual space. Further, the generated virtual space map may be transmitted to a separate server or provided to another mobile terminal. In addition, since the virtual space map accepts access from another mobile terminal, two or more terminals can access one virtual space map to control the character.

As described above, the virtual space map is generated through virtual reality and augmented reality. Virtual reality is mainly applied to a remote, or long distance, terminal (hereinafter, referred to as a first terminal) 220, and the augmented reality is applied to an in-space terminal (hereinafter, referred to as a second terminal) 240 existing in the actual space. Further, the first terminal 220 accesses the virtual space map through a virtual reality 230, and the second terminal 240 accesses the virtual space map through an augmented reality 250. The first terminal does not exist in the virtual space, and the second terminal exists in the virtual space. For example, when the virtual space is a living room within the home, the first terminal 220 exists in an area outside of the living room, and the second terminal 240 exists in the living room. The first terminal 220 can access the living room of the virtual space because the first terminal 220 pre-stores the virtual space map. Further, the first terminal 220 can control a TV, a set top box, a digital photo frame, a computer, an electric curtain, and the like, existing in the living room through the virtual space map. As described above, the first terminal 220 stores one or more virtual space maps. Accordingly, the first terminal 220 can control an electronic device really existing in the living room through the virtual space map because a communication connection is set between the electronic device existing in an actual space 210 and a character 260 (corresponding to each electronic device) on the virtual space map.

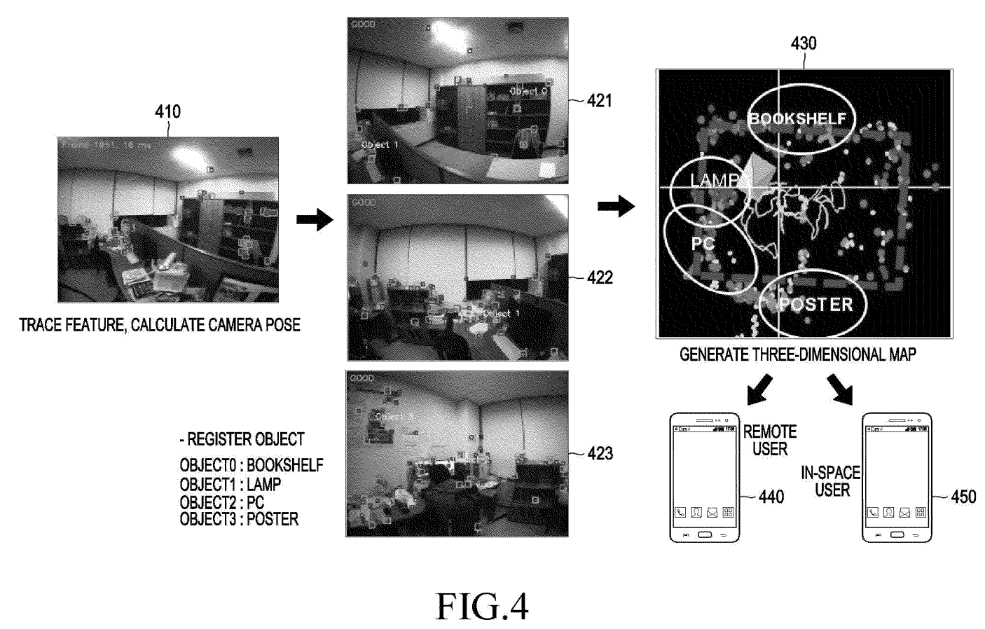

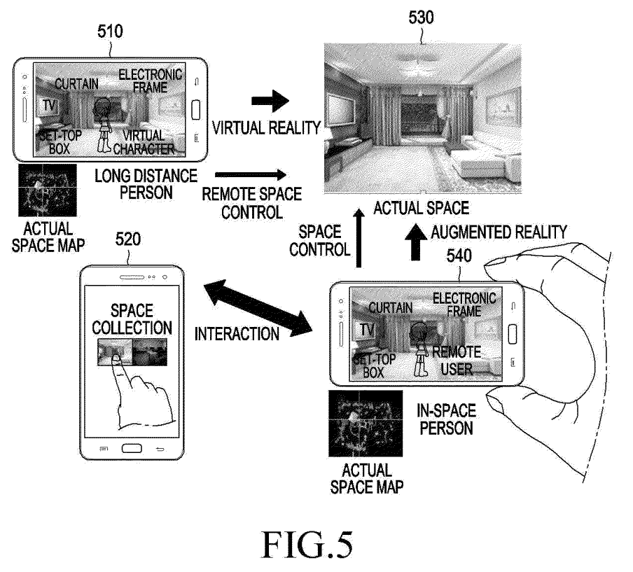

Similarly, the second terminal 240 can also control the existing electronic device through the virtual space map, like the first terminal 220. The virtual space map provides an environment for communication between the first terminal 220 and the second terminal 240, and also provides an environment for communication between an augmented character existing in a camera image displayed in the second terminal 240 and a character existing in the actual space corresponding to the augmented character. The virtual space map 210 includes the character 260 of the mobile terminal, which is accessing the virtual space map, as well as the character corresponding to the electronic device. A position of the mobile terminal in the virtual space map may be acquired via SLAM technology by using map information and information on the image photographed by the camera of the current mobile terminal. The character of the electronic device has a similar shape to that of the character of the actual space, but the character of the mobile terminal may be set to various types of characters according to a user preference. The character of the mobile terminal is also allocated an inherent identifier of the mobile terminal. Thus, it is possible to perform communication via a message, e-mail, or file transmission, by clicking or selecting a character of another mobile terminal. In addition, since the character of each mobile terminal can move on the virtual space map, a current state of another mobile terminal can be grasped in real time. The virtual space map generated through the above-described process will be described in detail below with reference to FIG. 4. Further, an example where the user interacts with and controls an object within the virtual space map on the virtual space map will be described in detail with respect to FIG. 5.

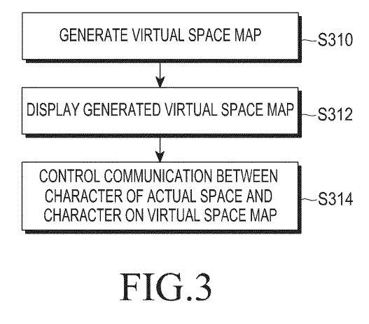

FIG. 3 is a flowchart illustrating virtual space map generation and a remote control method of the mobile terminal through the virtual space map generation, according to an embodiment of the present invention.

Each mobile terminal generates a virtual space map by photographing an actual space through one or more camera modules mounted to the mobile terminal, in step S310. The virtual space map is generated using image information, such as information on a feature, a texture, and the like, in an image of the photographed actual space, or is generated by fusing the image information using a gyro and a depth sensor. Further, the virtual space map includes annotation information on a character, which the user desires to register. Accordingly, the virtual space map includes the character, such as a bookshelf, as well as one or more electronic devices existing in the actual space. Thereafter, each character on the virtual space map is allocated an inherent identifier allocated to the character of the actual space. Specifically, the inherent identifier allocated to the character existing in the actual space is equally allocated to the corresponding character on the virtual space map. Such an allocation process may be input by the user. Alternatively, when the virtual space map is generated, the mobile terminal can identify the character by using a feature, a texture, a gyro sensor, a depth sensor, and the like, and can also allocate the inherent identifier.

The virtual space map generated in step S310 is displayed in a display unit, in step S312. In addition, the display unit displays an image photographed in real time by the camera. The display unit can move, enlarge, and reduce the virtual space map through a touch input, a keypad, a motion sensor, and the like. The first terminal is used for searching the displayed virtual space map, and the second terminal displays camera image information and information on a registered virtual character. If necessary, the second terminal may display the virtual space map, so that an inside of the space can be searched without a direct movement of the user within the space. Further, the display unit of the first terminal receives a command for controlling the character of the actual space input through the character on the displayed virtual space map. The virtual space map displayed in the display unit can be moved in up, down, left and right directions, and can also be enlarged or reduced by a touch input for controlling a movement of the mobile terminal or a movement of the virtual space map.

Communication between the character of the actual space and the character of the virtual space map is controlled, in step S314. Alternatively, communication between the remote terminal and the in-space terminal is controlled, and also communication between the character of the actual space and the augmented character is controlled through the in-space terminal. Specifically, the mobile terminal controls the communication between the characters by transmitting the command for controlling the character of the actual space to the character of the actual space through the display unit. In the first terminal, the command for controlling the character of the actual space is transmitted by selecting the character (that is, character corresponding to the character of the actual space) shown in the virtual space map. In the second terminal, the command for controlling the character of the actual space may be transmitted by selecting the augmented character displayed together with the camera image. Further, communication between the character of the actual space and the character of the virtual space corresponding to the character of the actual space is controlled. As described above, in order to control the communication between the characters, the same inherent identifier is allocated to the character on the virtual space map and the character of the actual space corresponding to the character on the virtual space map. The communication is controlled through the allocated inherent identifier. Further, the movement of the character on the virtual space map is controlled through a keypad, a touch input, or a motion sensor.

FIG. 4 illustrates an example of virtual space map generation, according to an embodiment of the present invention.

The mobile terminal generates a virtual space map by photographing the actual space through one or more camera modules mounted to the mobile terminal. A generated virtual space map 410, has one or more characters, such as a bookshelf, a computer, a telephone, a lamp, and the like, and features are traced or extracted from each character as indicated in the virtual space map 410. Further, a camera pose is calculated through the traced or extracted features. The virtual space map, as shown in reference numerals 421, 422 and 423, 410 illustrates an example of features of the characters photographed according to a rotation of the camera. A type and an inherent number of each character may be registered through the features traced or extracted. For example, inherent information (for example, an IP address and the like) of the computer is registered in the character of the computer. Through such a registration process, characters of the actual space can be allocated inherent information. Further, as indicated by reference numeral 430, a three-dimensional virtual space map is generated using features extracted from a bookshelf, a lamp, a computer, and the like. In addition, the generated three-dimensional virtual space map is transmitted to a mobile terminal 440 of the remote user or a mobile terminal 450 of the in-space user, and the character on the virtual space map is controlled through each mobile terminal.

FIG. 5 illustrates an example of interacting between mobile terminals and controlling the character within the virtual space map through the virtual space map, according to an embodiment of the present invention.

As illustrated in FIG. 5, the interaction between mobile terminals is provided and the character within the virtual space map is controlled using the generated virtual space map. The generated virtual space map has characters such as a TV, an electric curtain, a set top box, a digital photo frame, and the like, as indicated by a reference numeral 510. Since the characters are allocated respective inherent numbers, the characters may be controlled by the mobile terminal. A remotely located mobile terminal 520 may download or pre-store the virtual space map. One or more virtual space maps are stored, and a desired character in a desired space map may be remotely controlled through the virtual reality. The one or more virtual space maps may be classified into space collections according to a space type. The user can select a space that the user desires to control, from the space collections. Further, the virtual space maps may be grouped for each distance, and the grouped virtual space maps may be managed. A priority may be allocated to the virtual space maps according to position information or a favorite place, and the virtual space maps allocated the priority may be managed. In addition, a mobile terminal 540 located in an actual space 530 corresponding to the virtual space map has the same virtual space map as that of the mobile terminal 520 remotely located, and can control the character within the virtual space map through the augmented reality. The remote mobile terminal 520 and the in-space mobile terminal 540 can control the character within the virtual space map, and an interaction between the mobile terminals is possible.

It may be appreciated that the embodiments of the present invention can be implemented in software, hardware, or a combination thereof. Any such software may be stored, for example, in a volatile or non-volatile storage device, such as a Read Only Memory (ROM), a memory, such as a Random Access Memory (RAM), a memory chip, a memory device, or a memory Integrated Circuit (IC), or a recordable optical or magnetic medium, such as a Compact Disc (CD), a Digital Versatile Disc (DVD), a magnetic disk, or a magnetic tape, regardless of erasability or re-recordability. It can be also appreciated that the memory included in the mobile terminal is one example of machine-readable devices suitable for storing a program including instructions that are executed by a processor device to thereby implement embodiments of the present invention. Therefore, embodiments of the present invention provide a program including codes for implementing a system or method of the embodiments of the present invention and a machine-readable device for storing such a program. Further, this program may be electronically conveyed through any medium such as a communication signal transferred via a wired or wireless connection, and embodiments of the present invention appropriately include equivalents thereto.

In addition, the mobile terminal can receive the program from a program providing apparatus connected to the mobile terminal wirelessly or through a wire, and store the received program. The program providing apparatus may include a program including instructions to perform a preset content protecting method by a graphic processing apparatus, a memory for storing information required for the content protecting method, a communication unit for performing wired or wireless communication with the graphic processing apparatus, and a controller for transmitting the corresponding program to a transmitting/receiving apparatus by a request by the graphic processing apparatus or automatically.

While the invention has been shown and described with reference to certain embodiments thereof, it will be understood by those skilled in the art that various changes in form and detail may be made therein without departing from the spirit and scope of the present invention as defined by the appended claims.

What is claimed is:

1. A remote control apparatus of a mobile terminal using a virtual space map, the remote control apparatus comprising:
a virtual space map generator for generating the virtual space map;
a display unit for displaying the virtual space map; and
a controller for controlling communication between a character of an actual space and a character on the virtual space map.

2. The remote control apparatus of claim 1, further comprising a camera unit including one or more camera modules for photographing the actual space to generate the virtual space map.

3. The remote control apparatus of claim 1, further comprising a communication unit including one or more communication modules for transmitting a command for controlling the character of the actual space, wherein the command is input through the character on the virtual space map to the character of the actual space.

4. The remote control apparatus of claim 1, wherein the controller controls communication between the character of the actual space and an augmented character displayed in the display unit.

5. The remote control apparatus of claim 1, wherein the controller controls the communication by allocating an inherent identifier allocated to the character of the actual space to the character on the virtual space map.

6. The remote control apparatus of claim 2, wherein the controller calculates a camera position in an image of the photographed actual space by using Simultaneous Localization And Mapping (SLAM).

7. The remote control apparatus of claim 1, wherein the virtual space map generator generates the virtual space map by using one of a gyro sensor, a depth sensor, a texture, a feature, annotation information on the character of the actual space, a vertex of the character of the actual space, a side, and a brightness difference in a photographed image.

8. The remote control apparatus of claim 1, wherein the character of the actual space comprises at least one of a television, a washing machine, a refrigerator, a copy machine, a computer, a digital photo frame, and an electric curtain having a communication function therein, and a desk and a bookshelf having no communication function therein.

9. The remote control apparatus of claim 1, wherein the controller controls a motion of the character on the virtual space map through a keypad, a touch input, or a motion sensor.

10. The remote control apparatus of claim 1, wherein the controller registers the character in the virtual space map or deletes the character from the virtual space map.

11. The remote control apparatus of claim 1, wherein the virtual space map is generated based on a virtual reality and an augmented reality, and mutual communication is provided through characters of different mobile terminals existing in the virtual space map.

12. A remote control method of a mobile terminal using a virtual space map, the remote control method comprising the steps of:
generating a virtual space map;
displaying the virtual space map; and
controlling communication between a character of an actual space and a character on the virtual space map.

13. The remote control method of claim 12, further comprising photographing the actual space by using one or more camera modules in order to generate the virtual space map.

14. The remote control method of claim 12, further comprising transmitting a command for controlling the character of the actual space, wherein the command is input through the character on the virtual space map to the character of the actual space.

15. The remote control method of claim 12, wherein controlling the communication comprises controlling the communication by allocating an inherent identifier allocated to the character of the actual space to the character on the virtual space map.

16. The remote control method of claim 12, wherein generating the virtual space map comprises generating the virtual space map by using one of a gyro sensor, a depth sensor, a texture, a feature, annotation information on the character of the actual space, a vertex of the character of the actual space, a side, and a brightness difference in a photographed image.

17. The remote control method of claim 12, wherein controlling the communication further comprises controlling a motion of the character on the virtual space map through a keypad, a touch input, or a motion sensor.

18. The remote control method of claim 12, wherein the virtual space map is generated based on a virtual reality and an augmented reality, and mutual communication is provided through characters of different mobile terminals existing in the virtual space map.

19. A machine readable storage medium for recording a program for executing a remote control method using a virtual space map, which when executed implements the steps of:
generating a virtual space map;
displaying the virtual space map; and
controlling communication between a character of an actual space and a character on the virtual space map.

20. An article of manufacture for performing remote control using a virtual space map, comprising a machine readable medium containing one or more programs, which when executed implements the steps of:
generating a virtual space map;
displaying the virtual space map; and
controlling communication between a character of an actual space and a character on the virtual space map.
